(19) United States
(12) Patent Application Publication
(10) Pub. No.: US 2008/0119767 A1
(43) Pub. Date: May 22, 2008

(54) Device With Base For Accommodating Vibrating And Related Stimulating Attachments

(75) Inventors: Cheryl BERRY, St. Louis, MO (US); Michael STRAUGHN, Lee's Summit, MO (US)

Correspondence Address: LATHROP & GAGE LC, 2345 GRAND AVENUE, SUITE 2800, KANSAS CITY, MO, 64108, US

(73) Assignee: MY LITTLE SECRET, LLC, St. Louis, MO (US)

(21) Appl. No.: 11/780,277

(22) Filed: Jul. 19, 2007

Related U.S. Application Data
(60) Provisional application No. 60/831,786, filed on Jul. 19, 2006.

(51) Int. Cl. A61H 1/00; F16M 1/00; G06F 15/16

(52) U.S. Cl. 601/46; 248/678; 709/203

(57) ABSTRACT

There is disclosed a vibrator apparatus that includes a universal base and an attachment. The base is such that it can accommodate multiple vibratory and stimulatory attachments. The attachments are typically electrical, and draw power from the base, when coupled to the base, when the apparatus is on or activated. The base and attachments are such that they are separable from each other, such that once separated (decoupled), there are not any mechanical and electrical connections between these components. The base is such that it includes an audio player and memory for storing various vibratory modes. Data for the audio player as well as vibratory may be downloaded into the base from external sources, such as networks including the Internet.

### CROSS-REFERENCES TO RELATED APPLICATIONS

This application is related to and claims priority from U.S. Provisional Patent Application Ser. No. 60/831,786, entitled: Device With Base For Accommodating Vibrating And Related Stimulating Attachments, filed on Jul. 19, 2006, this provisional patent application incorporated by reference herein.

### TECHNICAL FIELD

Phallic and phallic-like devices for sexual stimulation, typically of the human female genitalia, are disclosed. In particular, disclosed are sexual stimulation devices with a universal base for receiving and operating multiple vibrating and/or stimulating attachments.

### BACKGROUND

Vibrators and other stimulating devices, typically phallic shaped, so as to simulate the human penis, are available worldwide. These devices are used as sexual aids, as well as for pleasure, for example, in achieving sexual climax or orgasm, typically in human females. Moreover, these devices are in more widespread use today, due to their greater public acceptance.

For example a vibrator known as the “rabbit” was the subject of an episode of the popular U.S. television show, Sex In The City. Additionally, vibrator devices are being more widely prescribed by sex therapists as part of treatments, and increased use of vibrators also results from the desire for sexual contact and stimulation, without the risk or fear of sexually transmitted diseases, from actual sexual contact from a human partner.

### SUMMARY

There is disclosed a vibrator apparatus that includes a universal base and an attachment. The base is such that it can accommodate multiple vibratory and stimulatory attachments. The attachments are typically electrical, and draw power from the base, when coupled to the base, when the apparatus is on or activated. The base and attachments are such that they are separable from each other, such that once separated (decoupled), there are not any mechanical and electrical connections between these components.

The disclosed subject matter is directed to a vibratory apparatus that is formed of a base and an attachment for the base, the attachment for moving or vibrating. The base includes a power supply and may coupling with one of multiple suitably adapted attachments. Each attachment is for mechanically and electrically coupling with the base, the electrical coupling including the base drawing electricity from the power supply in the base. The base and the attachment are such that separating (decoupling) them severs all mechanical and electrical connections between the base and the attachment.

The disclosed subject matter is also directed to a base for a vibratory apparatus. The base includes a housing designed for receiving a plurality of vibratory attachments in a mechanical coupling and a power system at least partially within the housing for electrically coupling with the attachment and providing power to the attachment, the electrical and mechanical couplings allowing for movement (vibration) of the attachment. The base also includes a controller at least partially within the housing, the controller electrically coupled to the power system, the controller for controlling the power in the power system and providing vibratory modes to an attachment for movement of the attachment when the attachment is electrically coupled to the power system and mechanically coupled to the housing.

The disclosed subject matter is also directed to a method for preparing a vibratory apparatus. The method includes providing a base for supporting a vibratory attachment such that the vibratory attachment is subject to movement (vibratory movement, for example, for stimulation) when electrically and mechanically coupled to the base. The base includes a housing for receiving a vibratory attachment from a plurality of vibratory attachments in a mechanical coupling and a power system at least partially within the housing, for providing power to an attachment when the attachment is electrically coupled to the power system and mechanically coupled to the housing, to allow for movement of the attachment. The base also includes a controller at least partially within the housing, the controller electrically coupled to the power system, the controller for controlling the power in the power system and providing vibratory modes to an attachment for movement of the attachment when the attachment is electrically coupled to the power system and mechanically coupled to the housing. An attachment from a plurality of attachments suitable for use with the base is then selected. The attachment is then mechanically coupled the housing, and it is electrically coupled to the power system. When the controller is activated, the attachment moves in a vibratory manner.

The disclosed subject matter is directed to a method for preparing a vibratory apparatus. The method includes providing a base for supporting a vibratory attachment such that the vibratory attachment is subject to movement when electrically and mechanically coupled to the base. The base includes a housing for receiving one of a plurality of vibratory or stimulatory attachments in a mechanical coupling. The base also includes a power system at least partially within the housing for providing power to an attachment when the attachment is electrically coupled to the power system and mechanically coupled to the housing, to allow for movement of the attachment, and a controller at least partially within the housing. The controller is electrically coupled to the power system, and is for controlling the power in the power system and providing vibratory modes to an attachment for movement of the attachment when the attachment is electrically coupled to the power system and mechanically coupled to the housing. There is also a port for receiving data for the controller, and the port is electrically coupled to the controller. The base is electronically linked to a data source, for example, a computer that has accesses the Internet or other network or that is suitably programmed with the requisite software, via a cable or other data transfer means, for transferring data for vibratory modes to the controller. the data transfer may be from a data source by downloading the data and receiving the data in the controller through the port.

Another disclosed method is a method for preparing a vibratory apparatus. The method includes providing a base for supporting a vibratory attachment such that the vibratory attachment is subject to movement when electrically and mechanically coupled to the base. The base includes a housing for receiving a plurality of vibratory attachments in a mechanical coupling. The base also includes a power system at least partially within the housing for providing power to an attachment when the attachment is electrically coupled to the power system and mechanically coupled to the housing to allow for movement of the attachment. There is a processor at least partially within the housing, the processor electrically coupled to the power system, and programmed to control the power in the power system and provide vibratory modes to an attachment for movement of the attachment when the attachment is electrically coupled to the power system and mechanically coupled to the housing. There is an audio player electronically coupled to the processor, and a port for receiving data electrically coupled to the processor. The base is electronically linked to a data source for transferring audio data to the audio player for playback as sound (through a speaker in the base) when the playback is activated. The transferring of the audio data from a data source may be by downloading the data and receiving the data in the audio player through the port.

### BRIEF DESCRIPTION OF THE DRAWINGS

Attention is now directed to the drawing figures, where like or corresponding numerals or characters indicate corresponding or like components. In the drawings:

FIG. 1A is a perspective view of an apparatus;

FIG. 1B is an exploded view of the apparatus of FIG. 1A;

FIG. 2 is a cross sectional view of exemplary motion mechanisms for the attachment taken along of line 2-2 of FIG. 1B;

FIG. 3A is a detailed view of the coupling structure of the attachment and base of the apparatus of FIG. 1A;

FIG. 3B is a bottom view of the attachment of the apparatus of FIG. 1A;

FIG. 4A is a partial cross-sectional view of the apparatus, of a side of the base and a cross sectional view of an attachment engaged with the base;

FIG. 4B is a cross sectional view of the apparatus of FIG. 4A having been rotated approximately 90° from the position shown in FIG. 4A; and,

FIG. 5 is a block diagram of the printed circuit board of FIG. 4B.

FIG. 6A is a side view of an alternate embodiment of a base;

FIG. 6B is a cross-sectional view of the base of FIG. 6A having been rotated approximately 90° from the position shown in FIG. 6A;

FIG. 7 is a block diagram of the printed circuit board of FIG. 6B;

FIG. 8 is a diagram showing the base in use with a computer in a temporary data connection for multiple applications;

FIG. 9A is a screen diagram of a web home page in which the user can utilize internet or other network based applications for the base of the apparatus;

FIG. 9B is a screen shot of a web page for downloading audio files for the audio player in the base, this page linked to the home page of FIG. 9A and various other web pages;

FIG. 9C is a screen shot of a web page for programming the base so as to control the motion of the requisite attachment, this page linked to the home page of FIG. 9A and various other web pages;

FIG. 10A is a screen shot of icons for use with the base of the disclosed subject matter when software for operation of the base and/or the apparatus is in the computer, and a diagram showing the base of the disclosed subject matter in use with the computer;

FIG. 10B is a screen shot where the base of the disclosed subject matter is programmable by a user, and a diagram showing the base of the disclosed subject matter in use with the computer; and,

FIG. 11 is a diagram of the base of the disclosed subject matter shown being recharged in a standard wall electrical outlet.

### DETAILED DESCRIPTION

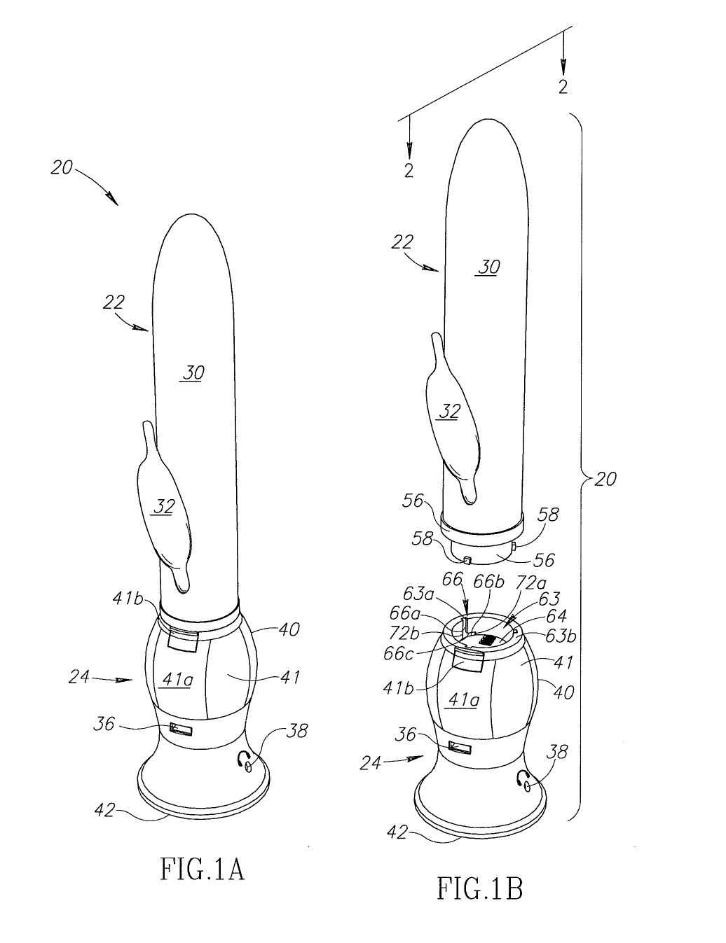

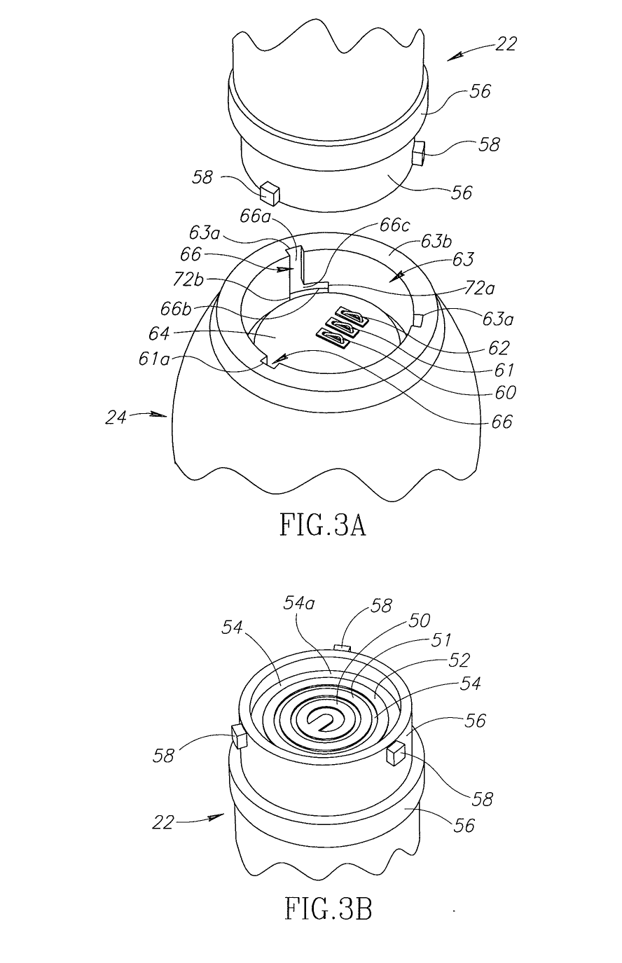

Turning to FIGS. 1A and 1B, the apparatus 20 is formed of an attachment 22, that is held in a base 24, when operation or storage is desired. The attachment 22 is typically coupled with, and retained in, the base 24 by a locking structure, partially on the attachment 22 and partially on the base 24, as detailed below. The attachment 22 is removable from the base 24. As shown in FIGS. 1B and 3A, the attachment 22 and base 24, when separated or decoupled, are free of all mechanical and electrical connections to each other.

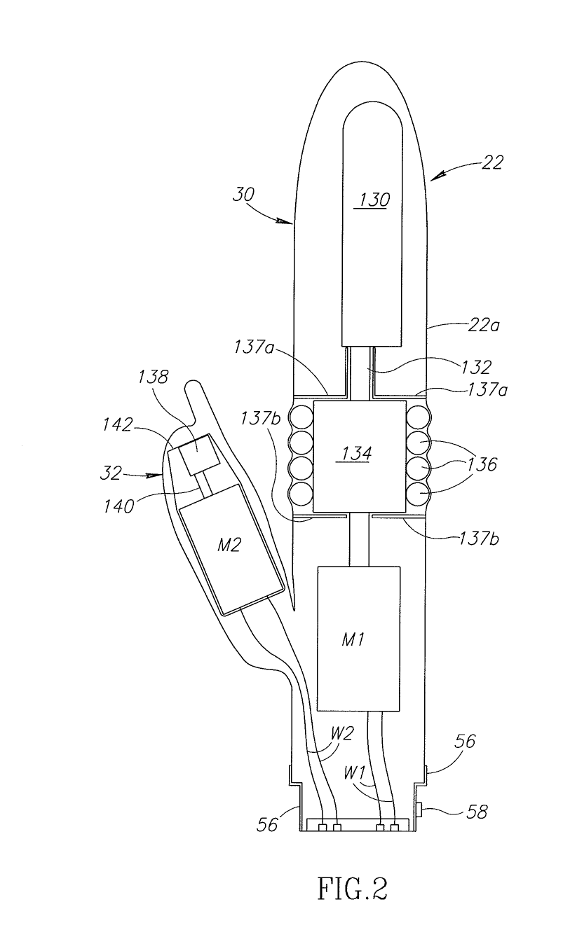

The attachment 22 is typically phallic shaped. The attachment 22 also includes motors. The attachment 22 includes electronics for drawing power from the base 24 (the electronics therein), to power its one or more motors. These motors typically cause the attachment to vibrate, rotate, twist, pulsate, combinations thereof, and the like. The attachment 22 includes a typically a rigid structure, such that at least its main portion 30 has a similar feel and appearance to that of a human penis in an aroused or erect state. The attachment 22 includes at least a coating or outer layer of rubber, plastic or other polymeric material, forming an outer surface 22a over the attachment 22 (main portion 30 and branch or rabbit potion 32) that is waterproof (inert to water and other bodily fluids), so as to protect the motors (for example, M1 and M2, associated components and wiring, including wires W1, W2, as shown in FIG. 2) therein from water, other bodily fluids and/or the ambient environment. The attachment 22 along its outer surface 22a, particularly along the phallic or main portion 30, may be textured to closely replicate a human penis.

One attachment 22, for example, may in a configuration commonly known as the “rabbit”. For example, as shown in FIG. 2, the “rabbit” is a dual motor structure. One motor M1 rotates a phallic shaped main member (portion) 30, to create vibration (by spinning an eccentric member 130 mounted on a rotating shaft 132, and also may include the shaft 132 spinning a drum 134 that moves beads or balls 136 (for example, of a plastic or ceramic material), held in place by the edges 137a, 137b of the materials that form the phallic or main portion 30). The other motor M2 spins an off-center weight 138 on a shaft 140 (within a capsule 142) in a branch or “rabbit” member (portion) 32, extending from the phallic shaped main member 30, to create vibration or movement.

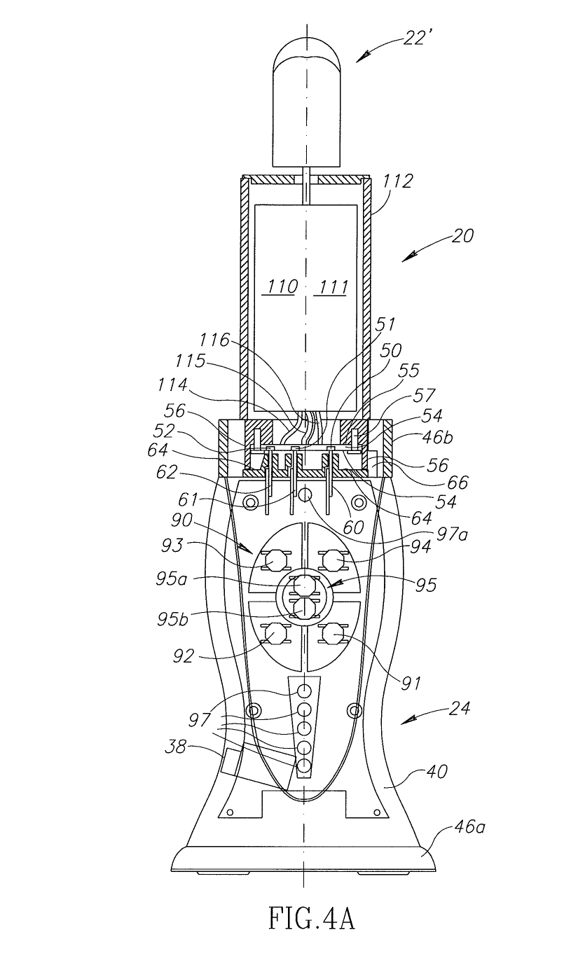

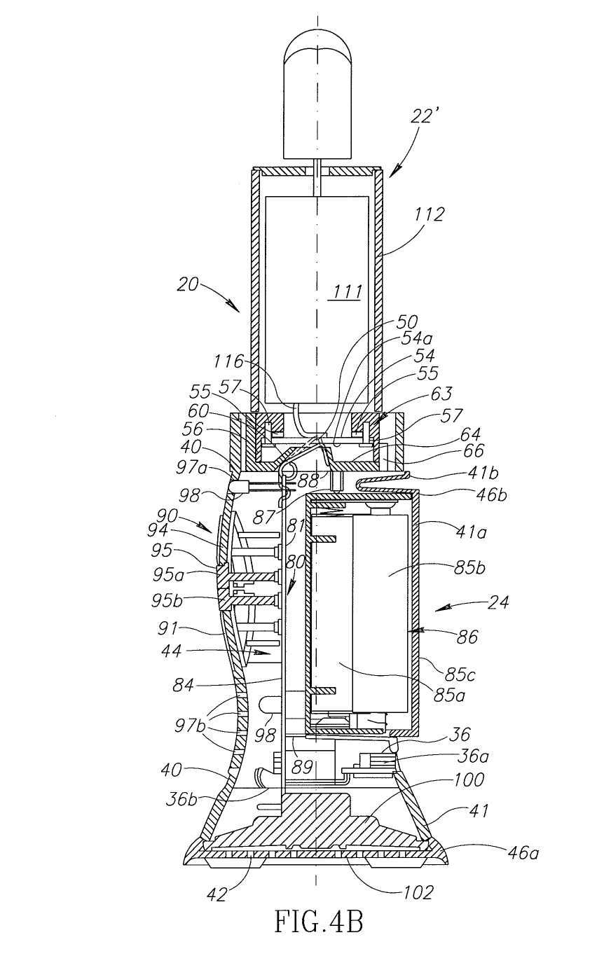

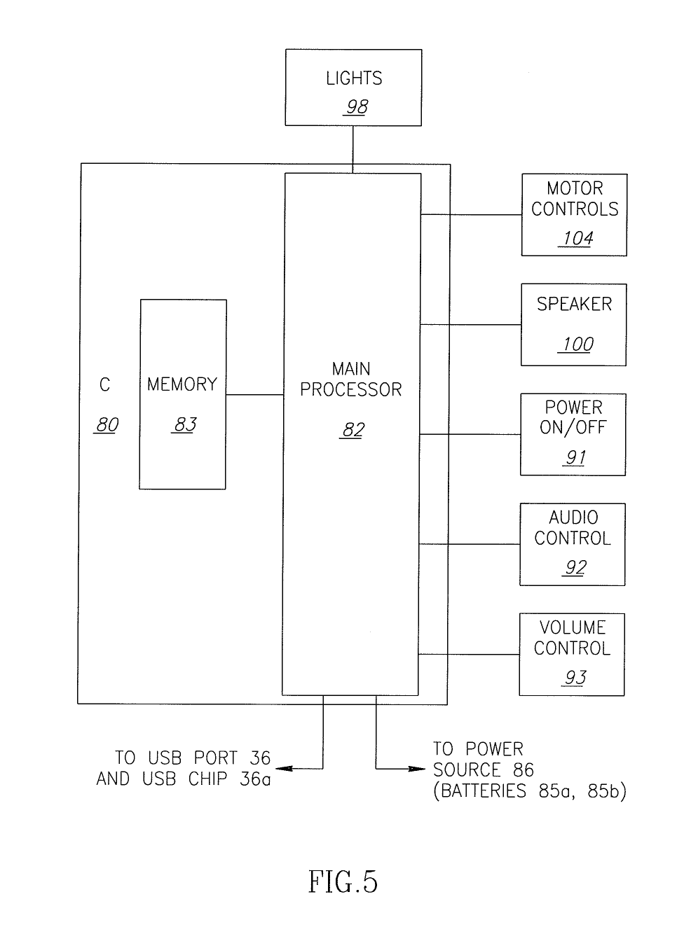

The motors M1, M2 are operated at different speeds, typically preprogrammed into the processor 82 associated with this “rabbit” functionality (for example, the RABBIT button 94 (FIG. 4A) on the base 24), by the manufacturer or through a computer (detailed below). This allows the requisite attachment 22 to create a variety of sensations. Alternately, the motors M1, M2 may be controlled by the user (pressing buttons 94, 95a, 95b) to vibrate at the desired speeds for the desired sensations, as, for example, detailed below.

The base 24 (shown in FIGS. 4A and 4B and detailed below) includes electronics, a power supply, processors, controls and the like, for powering, and typically controlling, the attachment, for example, the attachment 22, used with the base 24. The base 24 also includes other functionalities, electronics and the like, such as a Universal Serial Bus (USB) port 36 or other data, signal and/or electrical receiving port, for example, infrared, Bluetooth™, other wireless port, or the like, and an earphone jack 38. The base 24 is typically of a curved profile, to accommodate gripping by a human hand. The base 24 is typically formed of two shells 40 (first or front), 41 (second or rear), that when joined with a cap member 42, form a cavity 44 for the components of the base 24. A removable door 41a, releasable by a moveable clip 41b, forms part of the second shell 41, through which access to the batteries 85a, 85b (in a battery housing 85c) (FIG. 4B) of the power supply 86 (FIG. 4B) is obtained. The base 24 typically terminates in a flat end 46a, so that it may be placed in a standing position, when placed onto a surface.

Turning also to FIGS. 3A and 3B, the structures for the mechanical and electrical connections on the attachment 22 (FIG. 3B) and base 24 (FIG. 3A) are shown. The attachment 22 typically includes three circular electrical contacts 50, 51, 52, on a printed circuit plate 54. The plate 54 supports the electronics, processors and other supporting components, etc.

The contacts 50, 51, 52 are of an electrically conductive material, typically a metal, that is inert to water (will not oxidize or rust when in contact with water). The printed circuit plate 54 may be of a waterproof electrically insulating material, or alternately, an electrically insulating material coated with a waterproof material on its outer side 54a, for example, a plastic or polymeric material. The plate 54 is sealed along its periphery by an O-ring 55, positioned between the plate 54 and the collar 56 of the attachment 22 (the collar is also for example, of a waterproof material, such as plastics or polymers). The plate 54 is held in place by screws 57 (FIGS. 4A and 4B), that frictionally hold the O-ring 55 (FIGS. 4A and 4B) in place. This arrangement, coupled with the waterproof coating material for the main 30 and branch or rabbit 32 portions, renders the attachment 22 waterproof, whereby it can be cleaned by complete emersion in water, including being washed in a conventional dishwasher.

The collar 56 also includes protruding shoulders 58. These shoulders 58 engage corresponding portions on the base 24, to join and lock the attachment 22 on the base 24.

The contacts 50, 51, 52 are arranged for aligning with and contacting a corresponding spring clip 60, 61, 62 in the mouth 63 of the base 24. The spring clips 60, 61, 62 are pivotally mounted to the printed circuit board 84 of the base 24 (FIGS. 4A and 4B) and extend through the floor 64 of the mouth 63 of the base 24, located at the end 46b of the base 24 opposite the flat end 46a. Through the spring clips 60, 61, 62 (when in contact with the respective contact 50, 51, 52), electricity is transferred from the base 24 to the attachment 22′, for powering the motors 110, 111 (FIGS. 4A and 4B) of the attachment 22′. The spring clips 60, 61, 62 are of an electrically conductive material, such as an electrically conductive metal, that like the material of the electrical contacts 50, 51, 52 is inert to water.

The collar 56 of the attachment 22 is of a diameter slightly smaller that the inner diameter of the mouth 63 of the base 24. Indents 66, that are, for example, L-shaped, extend from the upper edge 63a along the ring portion 63b of the mouth 63, downward to or proximate to, the floor 64 of the mouth 63. The indents 66, include a first (upper) 66a, that is designed to receive the shoulders 58 of the collar 56. The shoulders 58 are such that initially, when the attachment 22 is placed into the mouth 63 of the base 24, the shoulders 58 can be moved, through the first portion 66a of the indent 66, toward the floor 64 of the mouth 63, into a second (lower) portion 66b of the indent 66.

Upon rotation or twisting of either the attachment 22 in the base 24, vice versa, or combinations thereof, the shoulders 58 slide in the second portion 66b of the indents 66, along the floor 64, typically until contacting a first protruding surface 72a at the end of each second portion 66b of the indent 66. Also, this second portion 66b of the indent 66 may include a surface 66c that is tapered outward (from first protruding surface 72a of the second portion 66b of the indent 66, to the second protruding surface 72b of the second portion 66b of the indent 66) to frictionally contact and retain the shoulders 58, in the second portions 66b of the indents 66. This frictional engagement of the shoulders 58 in the indents 66, is, for example, a temporary locking between the attachment 22 in the base 24, and serves as the mechanical connection between the attachment 22 and the base 24.

Turning to FIGS. 4A, 4B, and 5, the base 24 is illustrated in detail. The base 24 is shown with an attachment 22′, to illustrate the electrical and mechanical connections therebetween. The base 24 includes a controller or control unit (C) 80, typically one more processors such as microprocessors, such as preprogrammed and programmable microprocessors (i.e., a main processor or processor chip 82, such as a U1 MS8802-64pin, electrically coupled to memory or a memory chip 83, such as a U7 FLASH29U128) on a printed circuit board (PCB) 84. The printed circuit board 84 is wired to include all requisite electrical connections between the various components detailed above and below, to form a circuit, thorough which the base 24 is powered and from which the attachments (for example, attachment 22′) will draw power (e.g., electricity, electric current). For example, the processor chip 82 and memory chip 83 form the structure for receiving audio data (digital) (from downloads from networks and the like) and playing the data, to define an audio player, that converts the data so that sound is emitted through the speaker 100. The audio player may be an MP3 (MPEG-1 Audio Layer-3, MPEG-Moving Picture Experts Group) player. The processor 82 and memory chip 83 also control the lights 98.

The processor 82 and memory 83 also control vibrator modes and functions. For example, the controller or control unit (C) 80 is programmable to receive a plurality of vibratory modes for a plurality of attachments (either preprogrammed into the processor 82 or downloaded through the USB port 36). In a standard mode, one of several selectable preprogrammed modes controllable by pressing button 95a, the attachment 22 is such that the motor M1 (FIG. 2) is activated and the main portion 30 is rotated, when button 95b is pressed. When the rabbit function of button 94 is pressed, the motor M2 (FIG. 2) is activated, and the branch or “rabbit” portion 32 of the attachment 22 moves or vibrates.

The electrical components, including those on the printed circuit board 84, receive their power from batteries 85a, 85b (in a battery housing 85c) (the batteries 85a, 85b either single use or rechargeable, with the printed circuit board 84 and associated electronics wired accordingly), that serve as a power supply 86 for the base 24 and ultimately, the apparatus 20. The power supply 86, is wired (by one or more wires 87), to one or more electrical contacts 88, for contacting the respective spring clips 60, 61, 62, when the spring clips 60, 61, 62 are moved toward the base 24 (from the relaxed position, as shown by the spring clip 60 in broken lines, to the compressed position, in solid lines, in FIG. 4B), when the attachment (for example, attachment 22′) is coupled (connected) to the base 24 for operation of the apparatus 20. The spring clips 60, 61, 62 are electrically connected to the wiring of the printed circuit board 84. Similarly, wires (shown by the wire 89).are electrically connected from the power supply 86 to the wiring of the printed circuit board 84, completing the circuit. (When the spring clips 60, 61, 62 are in their relaxed positions, as shown by the broken line spring clip 60 of FIG. 4B, the circuit is open, and electricity is not flowing through the base 24.)

A control panel 90 is on the outer side of the base 24. This control panel 90 includes buttons 91-95 (FIG. 4A), that when pressed, causes the control unit (C) 80 to activate or deactivate the various functions provided for by the buttons 91-95. The control panel 90 also includes openings 97a, 97b for lights, such as diodes 98. The diodes 98 are, for example, mounted on the printed circuit board 84 and are controlled by the logic programmed into the control unit (C) 80.

There is a MAIN ON/OFF button 91, in which the power in the base 24 is activated, turned ON, and deactivated, turned OFF. This ON/OFF button, when pressed, causes the aforementioned circuit to be opened (turning the power OFF) or closed (turning the power ON) on the printed circuit board 84.

Button 92 is to PLAY AUDIO, with the audio therefor either programmed internally, or received through the USB Port 36 (that is connected to a USB chip 36a, that is connected to the printed circuit board 84 by one or more wires 36b). When depressed, this button 92 activates or deactivates the requisite portion of the printed circuit board 84, to play or stop the audio. The audio is typically transmitted through a speaker 100 in the base 24, through openings 102 in the cap member 42. The user can also install earphones through the earphone jack 38, this jack wired to the printed circuit board 84. Button 92 is also shown in the block diagram of FIG. 5 as AUDIO CONTROL. This button 92 also controls the switching of the audio tracks (downloaded through the USB port 36 or programmed internally) in the audio player (detailed above).

Button 93 is to control the volume of the audio being played and is indicated as VOLUME CONTROL. When depressed, this button 93 causes the requisite portion of the printed circuit board 84, to control the volume (increase or decrease) of the audio being played. Button 93 is shown in the block diagram of FIG. 5 as VOLUME CONTROL.

Button 94 is for RABBIT ON/OFF. This is a special button for when the “rabbit” attachment 22, detailed above, is coupled to the base 24. Activation of this button 94 causes the rabbit attachment 22 to operate or vibrate, in accordance with a preprogrammed operation, as per the logic programmed into the control unit (C) 80.

Button 95 includes two buttons 95a, 95b, both connected to the control unit (C) 80 of the printed circuit board 84. Button 95a is the VIBRATOR MODE button and allows the user to select various preprogrammed vibrator modes (as programmed in to the microprocessor). Button 95b is for manually controlling the vibrator attachment, such as attachments 22 and 22′, and is indicated as VIBRATOR CONTROL. The electronics associated with the buttons 94, 95 (95a, 95b) are indicated as MOTOR CONTROLS 104 on the board 84 of FIG. 5.

The attachment 22′ typically includes motors 110, 111, within a motor housing 112, although a single motor is also suitable. Each respective motor 110, 111, typically includes one or more wires 114, 115, 116 that connect to the requisite electrical contact 50, 51, 52 on the plate 54, from which power for the motors 110, 111 is drawn from the base 24, through the respective spring clip 60, 61, 62. The plate 54 is typically connected to the motor housing 112 by screws 57 or the like, and sealed by the O-ring 55, or the like.

Attention is now directed to FIGS. 1-5, to detail exemplary operations of the apparatus 20. These operations include coupling the attachment 22 (and 22′) to the base 24 and decoupling the attachment 22 (and 22′) from the base 24. For description purposes, the attachment 22, for example, the “rabbit” attachment, is exemplary of the attachments useful with the base 24 to define the apparatus 20.

When the attachment 22 is coupled to the base 24, the attachment 22 is such that the collar 56 is brought into proximity with the mouth 63 of the base 24. The shoulders 58 of the collar 56 are aligned with the indents 66 (the first portions 66b). The shoulders 58 are placed into the indents 66, and moved in the indents 66 toward the floor 64 of the mouth 63 of the base 24. Once contact is made with the floor 64 (in the respective indents 66), the attachment 22 is rotated, for example, in a clockwise direction. Rotation continues until there is a firm friction fit, as each shoulder 56 abuts the surface 66c of the second portion 66b of the indent 66 and also, typically, the first end 72a of the second portion 66b of the indent 66, resulting in a temporary locking.

Contemporaneous with this coupling, the spring clips 60, 61, 62 are in contact (by alignment) with the respective electrical contacts 50, 51, 52 of the attachment 22, and are moved from their relaxed potions (shown in broken lines in FIG. 4B) to their compressed positions (shown in solid lines in FIG. 4B). In these compressed positions, the spring clips 60, 61, 62 contact the requisite electrical contacts 88, facilitating closure of the circuit. The ON/OFF 91 button is depressed, so that the circuit is closed, and power (electricity) can flow from the base 24 to the attachment 22, powering it. The user can then depress the buttons desired 92-95b, for the desired effect, and may depress the RABBIT button 94, if the rabbit attachment is the installed attachment. This will, for example, cause the branch or “rabbit” portion 32 to move or vibrate in addition to the main or phallic portion 30 (that is already moving or vibrating). The apparatus 20 may operated as desired, until turned off by the user depressing the ON/OFF button 91 or if the attachment 22 is decoupled (separated) from the base 24.

When decoupling (separating) of the attachment 22 from the base 24 is desired, the attachment 22 is rotated counterclockwise, until the shoulders 58 abut, or are close to, the second surface 72b of the indent 66. The attachment 22 is moved away from the base 24 (the base 24 may be also be moved away from the attachment 22), such that the shoulders 58 are within the first portion 66a of the indents 66, so as to ultimately clear the mouth 63 of the base 24. During this process, the spring clips 60, 61, 62 return to their relaxed position, and the circuit is opened, whereby power is not flowing through the base 24. A new attachment may be coupled with the base 24 as detailed above, if desired.

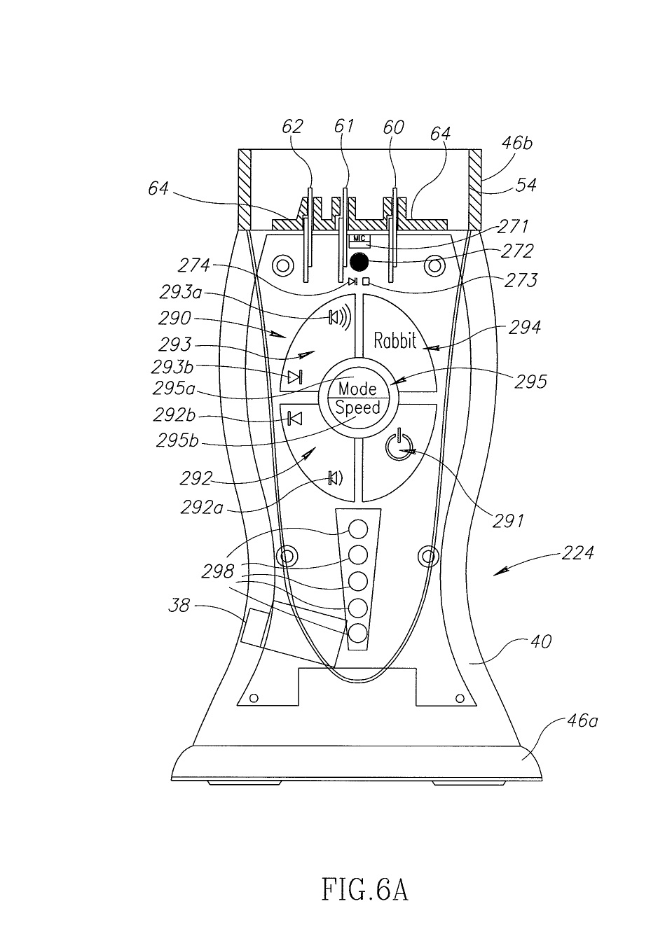

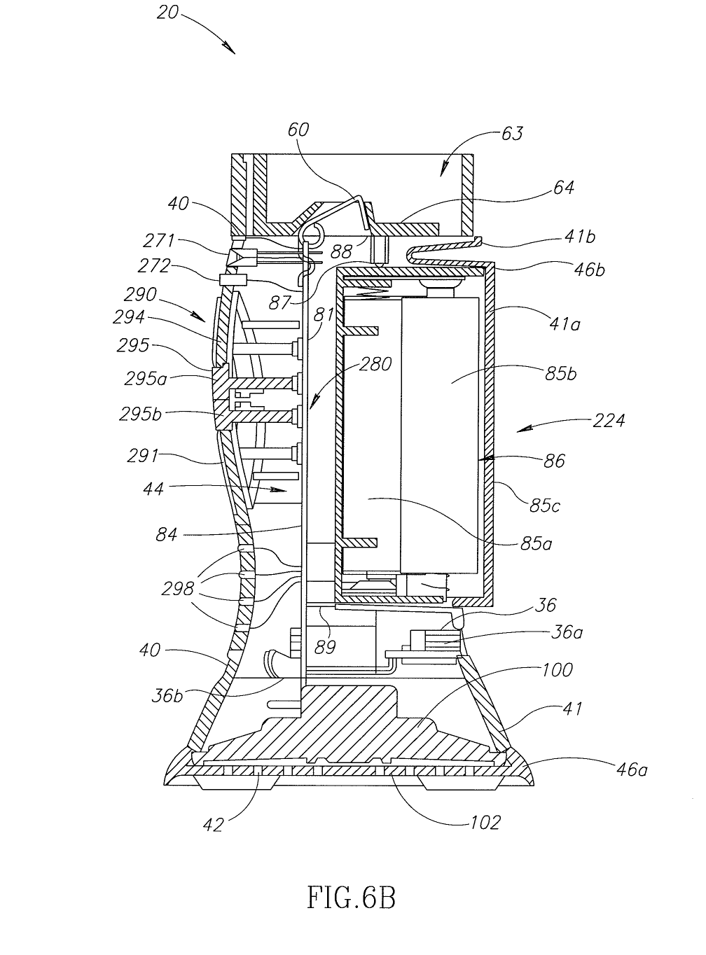

An alternate base 224 of the disclosed subject matter is shown in FIGS. 6A-11. In this embodiment, components similar to those of the base 24 in FIGS. 1A-5 have the same numbers, or the same numbers increased by “200” and numbered in the “200's”, with the descriptions of these components being the same as detailed above. Different components are described below for this alternate base 224.

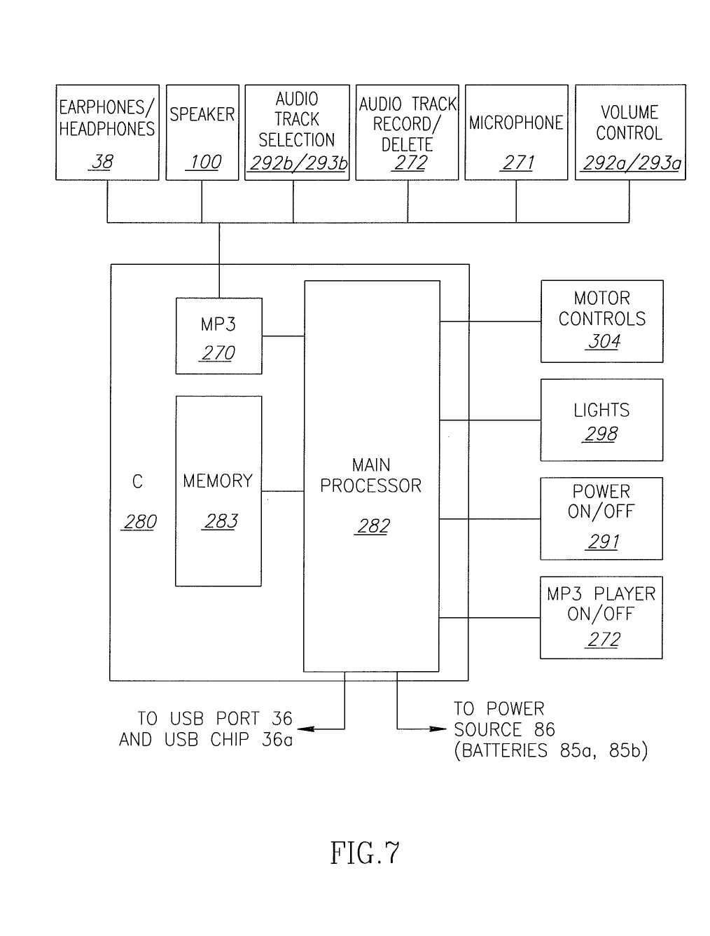

Turning to FIGS. 6A, 6B, and 7, the alternate base 224 is illustrated in detail. The base 224 is shown without attachments, with numerous suitable attachments permissible, for example, the attachment 22, with its main portion 30 and branch or rabbit portion 32, and the attachment 22′. The base 224 differs from the base 24 (detailed above and shown in FIGS. 1A-5) in that the audio player is a dedicated structure, for example, a separate MP3 player 270 on the circuit board 84 in the controller or control unit (C) 280. There is also a microphone 271, and a button 272, linked to the control unit (C) 280, for example, the MP3 player 270. The control panel 290 also differs slightly from the control panel 90 to accommodate the disclosed functions of the base.

The controller or control unit (C) 280 and its components are similar to the controller or control unit (C) 80, except that the main processor (processor chip) 282 and memory 283 (memory chip) assist the MP3 player 270 in performing the audio player function. The processor 282 is programmed, for example, for applications including those from networks, such as the Internet, and computers, such as those embodied in downloaded software and the like (with the memory 283 adapted accordingly). Additionally, the main processor 282, is, for example, programmed to recharge the batteries 85a, 85b or other power source through the USB port 36 or the earphone jack 38 (FIG. 11), and the printed circuit board 84 is wired for this recharging operation. The control buttons 291-295 are also adapted for this separate MP3 player 270 on the control unit (C) 280. Alternately, the MP3 player 270 may be located outboard of the controller (C) 280 on the printed circuit board 84 and would function as disclosed herein.

The MP3 player 270 may include a digital signal processor (DSP) for storing data, for example, media (audio) files as well as executing code and data/parameters, in memory such as flash memory and ROM (read only memory), performing audio/encode functions, executing post processing algorithms and performing system related tasks like file management and user interface control (from the buttons 272 and 291-295). The DSP also includes a peripheral interface that allows the user to control inputs and outputs and the audio tracks (files). The DSP is electrically coupled with an Audio CODEC (a device or program capable of performing encoding and decoding on a digital data stream or signal) for interfacing with computer lines, audio inputs, microphones, earphones/headphones and speakers for digitizing the audio in the DSP. The printed circuit board 84 also includes electronics for converting power from the batteries 85a, 85b or other power source to run the MP3 player 270 and its components.

The control buttons include a button 272 for controlling the microphone 271 and the MP3 player 270. To turn the MP3 player 270 ON and OFF, the button 272 is clicked once (visual indicator 273). If the button 272 is depressed for two seconds, it will activate the microphone 271 for recording an audio track that will be stored in the memory of MP3 player 270 (visual indicator 274). To erase the audio track from the memory of the MP3 player 270, while the audio is being played, the button 272 should be depressed for two seconds. The button 272 for controlling the MP3 player 270 is shown in FIG. 7 as MP3 PLAYER ON/OFF through the main processor 282, and AUDIO TRACK CONTROL and MICROPHONE RECORDING.

There is a MAIN ON/OFF button 291, in which the power in the base 224 is activated, turned ON, and deactivated, turned OFF. This ON/OFF button, when pressed, causes the aforementioned circuit to be opened (turning the power OFF) or closed (turning the power ON) on the printed circuit board 84.

Buttons 292 and 293 are divided into two sections, one for volume 292a (increase), 293a (decrease) and one for audio track selection 292b (advance), 293b (go back), depending on the area in which these buttons 292, 293 are depressed. These divided buttons, depending on the portions depressed for volume control 292a, 293a, are indicated in FIG. 7 as VOLUME CONTROL and for audio track selection 292b, 293b are indicated in FIG. 7 as AUDIO TRACK SELECTION. As detailed herein, the files for the audio for the MP3 player 270 are typically downloads from a network, such as the internet, through the USB port 36 (or other data and/or electrical port as detailed above), or programmed into the MP3 player 270, through the USB port 36.

The audio from the MP3 player 270 is transmitted through the speaker 100 (through amplifiers and the like), indicated in FIG. 7 as SPEAKER, or the earphone jack 38, indicated in FIG. 7 as EARPHONES/HEADPHONES.

Button 294 is for RABBIT ON/OFF. This is a special button, for example, when the “rabbit” attachment 22, detailed above, is coupled (connected) to the base 224. Activation of this button 294 causes the rabbit portion 32 of the rabbit attachment 22 to operate by moving or vibrating, in accordance with a preprogrammed operation, as per the logic programmed into the control unit (C) 280. The rabbit portion 30 now moves or vibrates with the already vibrating main portion 30. The control unit (C) 280, for example, the processor 282, is programmable so as to recognize that a rabbit attachment, such as attachment 22 is on the base 224, and will allow its vibratory operation in accordance with logic either downloaded or preprogrammed for the rabbit attachment (through the USB port 36).

Button 295 includes two buttons 295a, 295b, both connected to the control unit (C) 280 of the printed circuit board 84. Button 295a is the VIBRATOR MODE button and allows the user to select various preprogrammed vibrator modes (as programmed in to the microprocessor). Button 295b is for manually controlling the vibrator speed, and is labeled SPEED. The electronics associated with the buttons 294, 295 (295a, 295b) are labeled MOTOR CONTROLS 304 as indicated in FIG. 7.

Lights 298 are attached to the panel 41 and are directly wired to the printed circuit board 84. These lights are controlled by the main processor 282 and in FIG. 7 are indicated as LIGHTS.

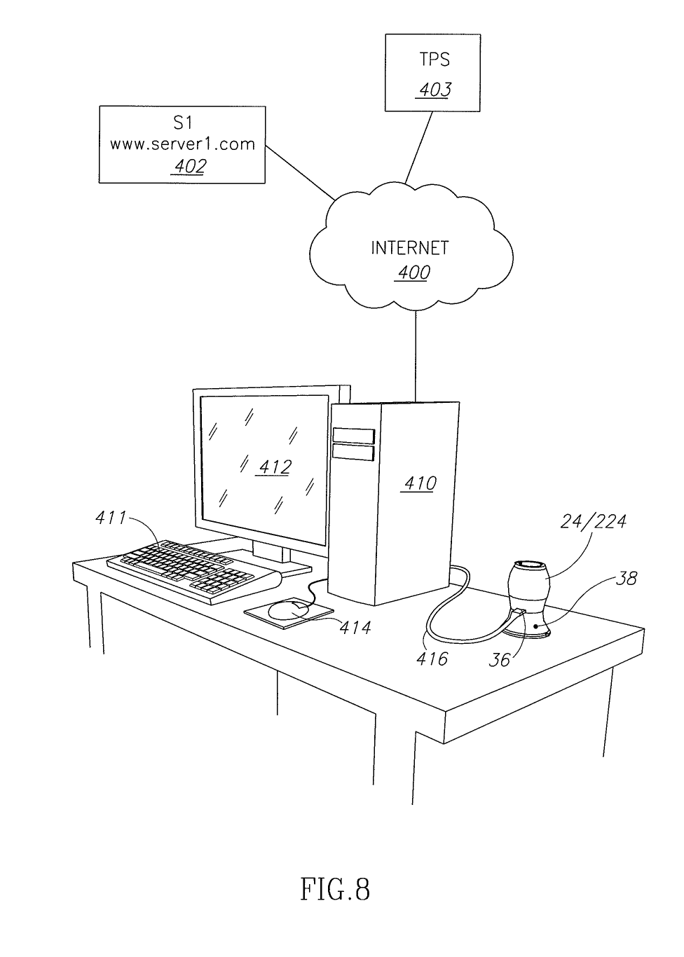

FIG. 8 shows the base 24/224 being used with network, such as Internet 400 applications. These applications include, for example, audio downloads, for the audio player or MP3 player 270, and vibrator control, control of the motors moving the attachment for the base 24/224. For example, the applications may be hosted in a server (S1) 402 associated with an entity or other designated party who makes, distributes, or otherwise provides the base 24/224. The server (S1) 402 for explanation purposes may have the uniform resource locator of www.server1.com.

The user links to the server (S1) 402, or a third party server (TPS) 403, depending on the data desired to be downloaded into the base 24/224 or obtained for the computer 410. Links to the servers 402, 403 are through a computer 410, with a keyboard 411 and monitor 412, whose on screen displays can be activated or clicked on by a mouse 414 or other pointing device. The computer 410 connects to the base 24/224 by a USB cable 416 or the like.

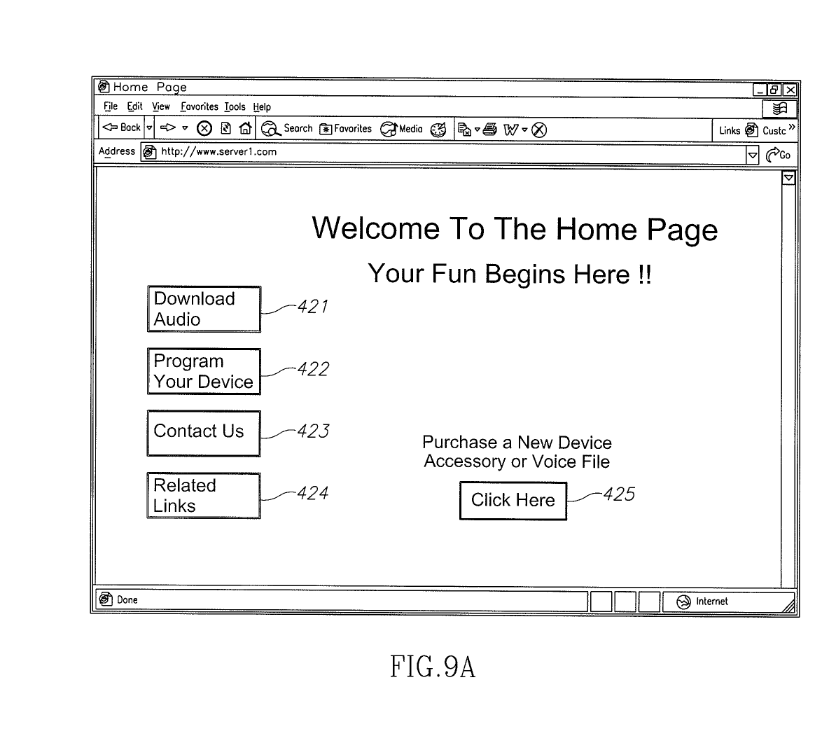

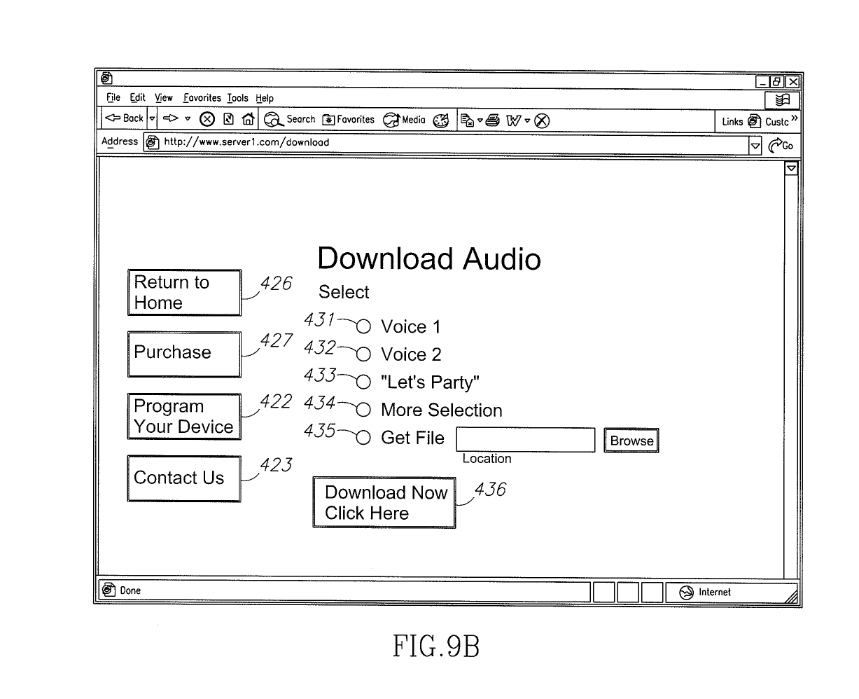

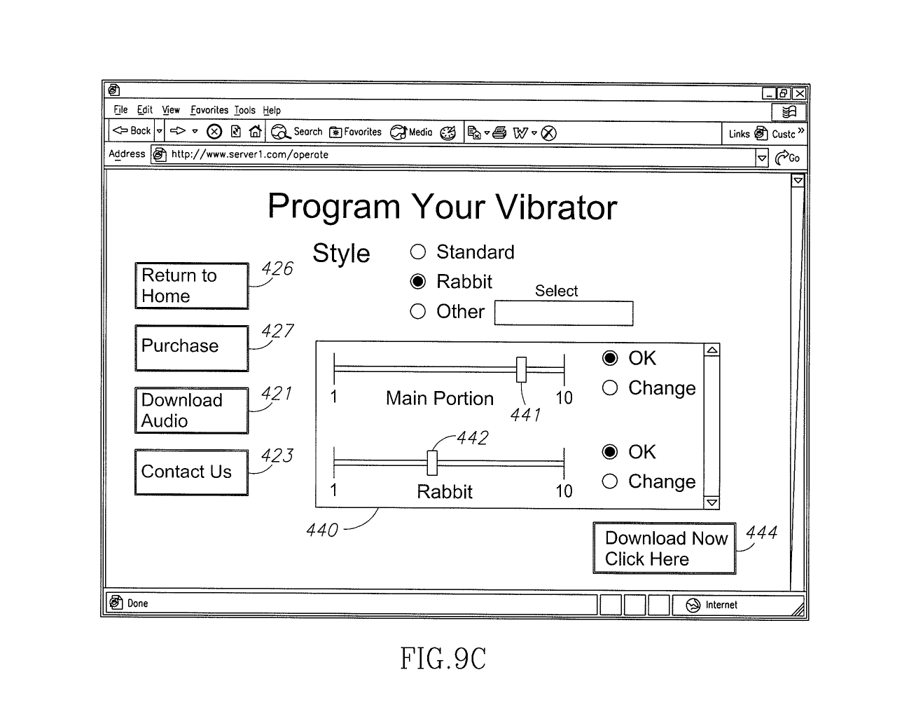

For example, should a web based application be desired for the base 24/224, the user enters the Uniform Resource Locator (URL) “www.server1.com”, to be directed to the server (S1) 402 that hosts the requisite web site and requisite home page, as shown in the screen shot of FIG. 9A. The user has many clickable portions 421-425, that if clicked by the mouse, will direct the user to the requisite web page for the requisite application.

Should the user wish to download audio, she clicks on portion 421 (also on the web page of FIG. 9C if she is there), where she is directed to the web page indicated by the screen shot of FIG. 9B. The user can now download the desired audio file for the requisite audio by clicking their mouse in the desired space 431-435, and then causing the downloading function to activate by clicking on box 436, so that the audio file is downloaded into the base 24/224, into the respective audio player (MP3 player 270 of the base 224). The user may import audio from other sources by clicking on space 435 (followed by the click on box 436 to download to the base 24/224). Portions 422, 423, 426, 427, for redirection to web pages associated with this web site are also provided on this web page.

The user can also program the base 24/224 for movement of the attachment, for example, the rabbit attachment 22, by either clicking portion 422 from the home page (FIG. 9A) or the download page (FIG. 9B) to arrive at the screen shot of FIG. 9C. The user enters the style of the attachment, for example, Standard, Rabbit or other. A control panel in the text block 440 will appear for that particular vibrator attachment. For example, for a rabbit attachment 22, for use with the base 24/224, the indicators 441, 442 are moved by dragging the mouse to set the levels of vibration, and then indicates if these levels are OK or should be changed. Once the settings are satisfactory to the user, the user clicks on the “download” portion 444, and this information is sent to the main processors 82/282 and stored in memory 83/283 (of the control unit (C) 80/280), for use when the base 24/224 with the requisite attachment is activated (turned on).

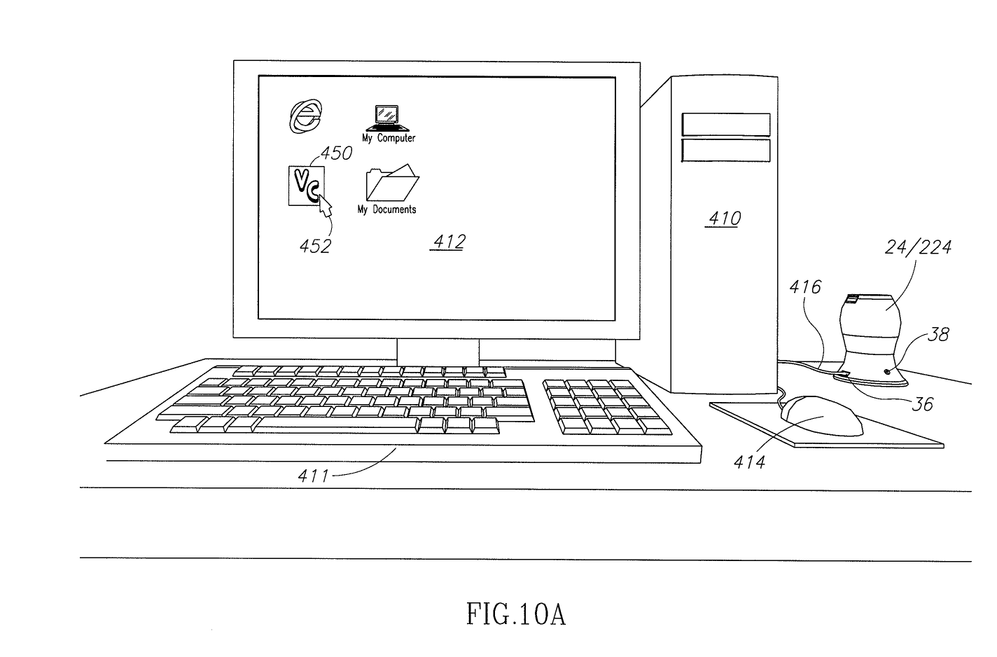

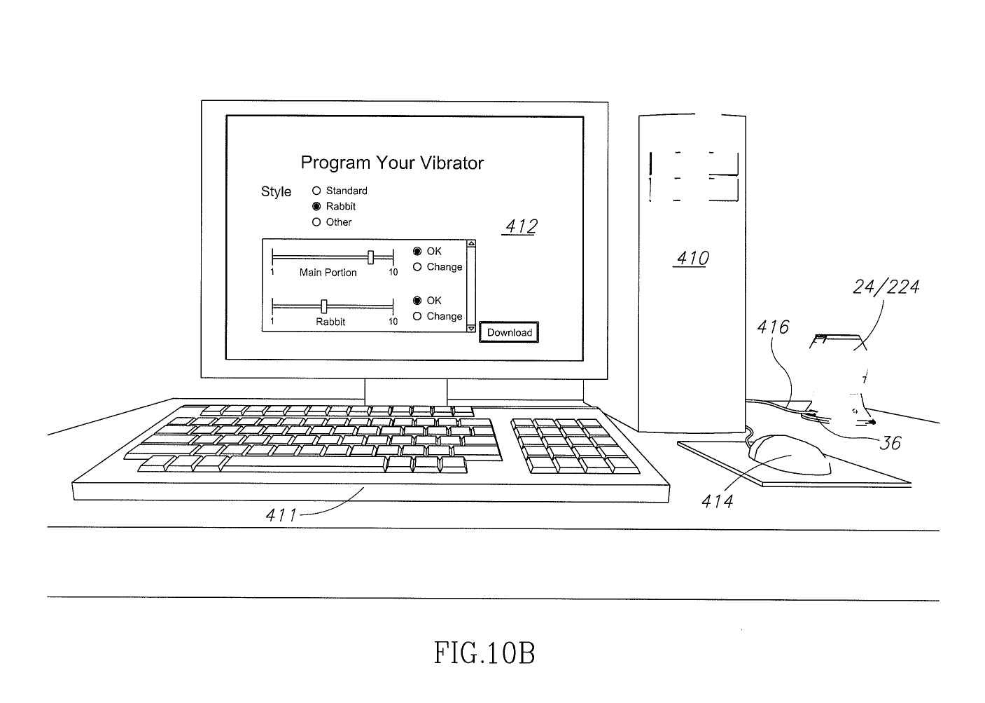

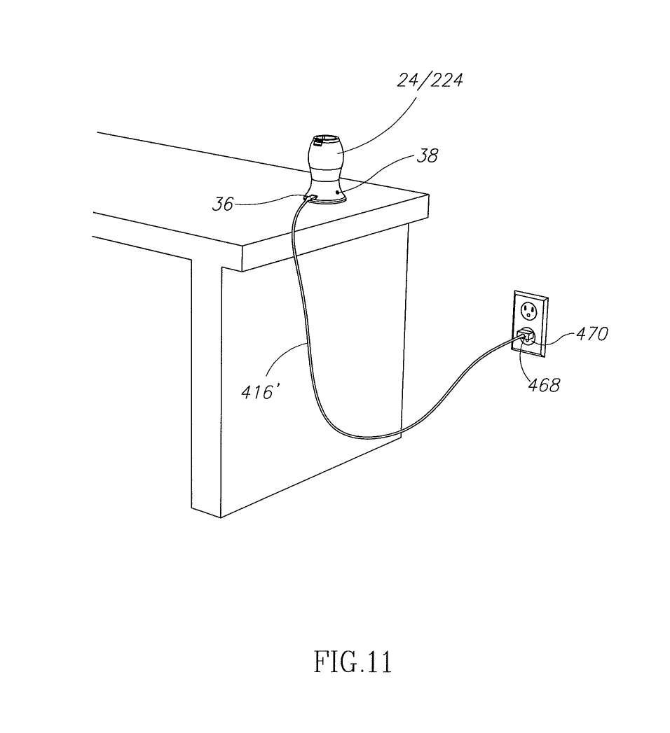

Alternately, the programming of the vibrator may be from previously downloaded software or the like, that appears as an icon 450 (“VC”) in the screen shot on the monitor 412, as shown in FIG. 10A. This icon 450 can be clicked on by the mouse, as shown by the arrow 452.

The screen shot, similar to that of FIG. 9C appears on the monitor 412 of the computer 410, as shown in FIG. 10B. The vibrator control is like that as described for FIG. 9C above.

FIG. 11 shows the base 24/224 being recharged through the USB port 36. Other ports are also suitable port so long as they are adapted for receiving electricity or other power. The USB cable 416′ is similar to the USB cable 416 except that it is adapted for a plug 468 to be electrically connected to a standard electrical outlet 470. As stated above, the base 24/224 is such that its printed circuit board 84 and controllers (control units) (C) 80/280 are designed for this recharging operation of the batteries 85a, 85b or other power source 86 in the base 24/224. Alternately, the USB cable 416′ may also be adapted to attach to a power pack or other power source for this recharging operation.

While directional references, such as upper, lower, front, rear, inner, outer and the like have been made herein, these references are exemplary only, to show the apparatus 20 and bases 24, 224 in exemplary orientations and operations.

While preferred embodiments of the disclosed subject matter have been described, so as to enable one of skill in the art to practice the disclosed subject matter, the preceding description is intended to be exemplary only. It should not be used to limit the scope of the disclosed subject matter, which should be determined by reference to the following claims.

What is claimed is:

1. A vibratory apparatus comprising:
a base including a power supply;
an attachment configured for mechanically and electrically coupling with the base, the electrical coupling including the base drawing electricity from the power supply in the base;
the base and the attachment configured such that decoupling severs all mechanical and electrical connections between the base and the attachment.

2. The apparatus of claim 1, wherein the base is configured for coupling with multiple attachments.

3. The apparatus of claim 1, wherein the base includes a controller, the controller including at least one processor coupled with at least one memory element; and, an interface for communicating with at least one external data source.

4. The apparatus of claim 3, wherein the base includes an audio player.

5. The apparatus of claim 4, wherein the audio player includes an MP3 player.

6. The apparatus of claim 4, wherein the at least one processor coupled with at least one memory element defines the audio player.

7. The apparatus of claim 4, wherein the interface includes a Universal Serial Bus (USB) port.

8. The apparatus of claim 7, wherein the audio player is configured for receiving data corresponding to audio files for being played by the audio player from at least one external data source.

9. The apparatus of claim 8, wherein the audio player is configured for receiving downloaded data.

10. The apparatus of claim 1, wherein the base includes means for operating separate portions of the attachment independent of each other.

11. The apparatus of claim 1, wherein the base is configured for recognizing the attachment and providing at least one vibratory mode for the attachment.

12. The apparatus of claim 3, wherein the controller is programmable to receive a plurality of vibratory modes for a plurality of attachments.

13. A base for a vibratory apparatus comprising:
a housing configured for receiving a plurality of vibratory attachments in a mechanical coupling;
a power system at least partially within the housing for providing power to an attachment when the attachment is electrically coupled to the power system and mechanically coupled to the housing to allow for movement of the attachment; and,
a controller at least partially within the housing, the controller electrically coupled to the power system, the controller for controlling the power in the power system and providing vibratory modes to an attachment for movement of the attachment when the attachment is electrically coupled to the power system and mechanically coupled to the housing.

14. The base of claim 13, additionally comprising a port for receiving data for the controller, the port electrically coupled to the controller.

15. The base of claim 14, wherein the port includes a Universal Serial Bus port.

16. The base of claim 13, additionally comprising an audio player.

17. The base of claim 16, wherein the audio player includes an MP3 player.

18. The base of claim 16, wherein the audio player forms part of the controller.

19. The base of claim 18, wherein the audio player is configured for receiving data corresponding to audio files for being played by the audio player from at least one external data source.

20. The base of claim 19, wherein the audio player is configured for receiving downloaded data.

21. The base of claim 13, wherein the controller is configured for recognizing the attachment and providing at least one vibratory mode for the attachment.

22. The base of claim 13, wherein the controller is programmable to receive a plurality of vibratory modes for a plurality of attachments.

23. A method for preparing a vibratory apparatus comprising:
providing a base for supporting a vibratory attachment such that the vibratory attachment is subject to movement when electrically and mechanically coupled to the base, the base comprising:
a housing configured for receiving a plurality of vibratory attachments in a mechanical coupling;
a power system at least partially within the housing for providing power to an attachment when the attachment is electrically coupled to the power system and mechanically coupled to the housing to allow for movement of the attachment; and,
a controller at least partially within the housing, the controller electrically coupled to the power system, the controller for controlling the power in the power system and providing vibratory modes to an attachment for movement of the attachment when the attachment is electrically coupled to the power system and mechanically coupled to the housing;
selecting an attachment suitable for use with the base;
mechanically coupling the attachment to the housing; and,
electrically coupling the attachment to the power system of the base.

24. The method of claim 23, additionally comprising: activating the controller for causing movement in the attachment.

25. The method of claim 23, wherein the selecting an attachment includes selecting an attachment from a plurality of attachments suitable for use with the base.

26. A method for preparing a vibratory apparatus comprising:
providing a base for supporting a vibratory attachment such that the vibratory attachment is subject to movement when electrically and mechanically coupled to the base, the base comprising:
a housing configured for receiving a plurality of vibratory attachments in a mechanical coupling;
a power system at least partially within the housing for providing power to an attachment when the attachment is electrically coupled to the power system and mechanically coupled to the housing to allow for movement of the attachment;
a controller at least partially within the housing, the controller electrically coupled to the power system, the controller for controlling the power in the power system and providing vibratory modes to an attachment for movement of the attachment when the attachment is electrically coupled to the power system and mechanically coupled to the housing; and,
a port for receiving data for the controller, the port electrically coupled to the controller; and,
electronically linking the base to a data source for transferring data for vibratory modes to the controller.

27. The method of claim 26, additionally comprising transferring data from a data source by downloading the data and receiving the data in the controller through the port.

28. The method of claim 27, additionally comprising:
selecting an attachment suitable for use with the base;
mechanically coupling the attachment to the housing; and,
electrically coupling the attachment to the power system of the base.

29. The method of claim 27, additionally comprising: activating the controller for causing movement in the attachment.

30. The method of claim 28, wherein the selecting an attachment includes selecting an attachment from a plurality of attachments suitable for use with the base.

31. A method for preparing a vibratory apparatus comprising:
providing a base for supporting a vibratory attachment such that the vibratory attachment is subject to movement when electrically and mechanically coupled to the base, the base comprising:
a housing configured for receiving a plurality of vibratory attachments in a mechanical coupling;
a power system at least partially within the housing for providing power to an attachment when the attachment is electrically coupled to the power system and mechanically coupled to the housing to allow for movement of the attachment;
a processor at least partially within the housing, the processor electrically coupled to the power system, the processor programmed to control the power in the power system and provide vibratory modes to an attachment for movement of the attachment when the attachment is electrically coupled to the power system and mechanically coupled to the housing;
an audio player electronically coupled to the processor; and,
a port for receiving data electrically coupled to the processor; and,
electronically linking the base to a data source for transferring audio data to the audio player for playback as sound when the playback is activated.

32. The method of claim 31, additionally comprising transferring audio data from a data source by downloading the data and receiving the data in the audio player through the port.

33. The method of claim 32, wherein the audio data includes audio files.

34. The method of claim 32, additionally comprising:
selecting an attachment suitable for use with the base;
mechanically coupling the attachment to the housing; and,
electrically coupling the attachment to the power system of the base.

35. The method of claim 34, additionally comprising: activating the controller for causing movement in the attachment.

36. The method of claim 34, wherein the selecting an attachment includes selecting an attachment from a plurality of attachments suitable for use with the base.
